(19) United States
(12) Patent Application Publication
(10) Pub. No.: US 2017/0183894 A1
(43) Pub. Date: Jun. 29, 2017

(54) Confinement locking bar

(71) Applicants: Simon Lepage, Quebec (CA); Guy Fiset, Quebec (CA)

(72) Inventors: Simon Lepage, Quebec (CA); Guy Fiset, Quebec (CA)

(21) Appl. No.: 15/382,677

(22) Filed: Dec. 18, 2016

(30) Foreign Application Priority Data
Dec. 23, 2015 (GB) 1522705.1

(51) Int. Cl. E05C 19/00; E05C 19/12

(52) U.S. Cl. CPC E05C 19/003; E05C 19/12

(57) ABSTRACT

A confinement locking bar is comprised of a bar made from a strong and resilient material and bolted at pivot bracket member to a door frame or any other strong location on a wall section proximal to a door to be secured. The bar is secured to a retainer member when it is in a vertical configuration. The bar has a latching member to latch on to when it is lowered into a horizontal “confinement” mode. The latching member is located on the opposite door frame. A blocker member is located on the door at a location where it is positioned in between the door and the bar when it is in confinement mode.

### FIELD OF THE INVENTION

The present invention relates generally to building safety and security but more particularly to a confinement locking bar.

### BACKGROUND OF THE INVENTION

Soon after the invention of the door came inventions related to securing that door. The earliest forms must have been to prop up a piece of wood with one end fitted in a notch carved in the floor and the opposite end squeeze against the door. There is also the horizontal bar that is run across the width of the door or even a double door and which is secured by a pair of brackets located on each side of the door. There is also a variation of the horizontal bar which is rotationally attached at one end on one side of the door so that when not in use it is vertical and when in use it rotates down into a bracket to the side of the door.

With the recent epidemic of shooting rampage, school and other public buildings are at risk. Schools especially are victims of such acts of violence. Police and other safety experts recommend that, when such an event occurs, to use all means necessary to lock a classroom door so as to create a “panic room”. What is recommended is to move all sort of furniture to block the door. The problem with that is that some of that furniture is heavy and hard to move, especially if a teacher is a kinder garden class where soliciting the help of children might not be an option.

### SUMMARY OF THE INVENTION

In view of the foregoing disadvantages inherent in the known devices now present in the prior art, the present invention, which will be described subsequently in greater detail, is to provide objects and advantages which are:

To provide for a confinement locking bar which quickly secures a door and gives more time to add additional barricades, should it prove necessary.

In order to do so, the invention comprises a bar member that is pivotally attached to a pivot bracket member fixedly connected to a wall section proximal one side of a door, and a latching member located on a wall section proximal an opposite side to the door for use by the bar member when it is in a horizontal configuration and wherein the bar member being held in a substantially vertical position, that is substantially parallel to the door by way of a retainer member. A blocker member fixedly attached to the door and positioned so that when the bar member is lowered the blocker member makes contact with the bar member so as to prevent any movement from the door.

The blocker member is wedge shaped vertically wherein a thin side is is located in an upper portion, and the latching member is also wedge shaped on both of its end segments.

Also, the latching member is two sided so that it can be installed on the right or left side of the door.

The bar member can optionally be locked in its upright position by a lockable retainer member having a locking member that moves a pin member in and out of a hole made through the bar member so as to selectively lock and unlock it.

The confinement locking bar is used in combination with a door.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be made to the accompanying drawings and descriptive matter which contains illustrated preferred embodiments of the invention.

### BRIEF DESCRIPTION OF THE DRAWINGS

FIG. 1 Front view of the invention in “not in use” mode.

FIG. 2 Front view of the invention in “in use” mode.

FIG. 3a Top view of the pivot member.

FIG. 3b Front, view of the pivot member.

FIG. 3c Side view of the pivot member.

FIG. 4a Top view of latching member.

FIG. 4b Side view of latching member.

FIG. 4c Front view of latching member when installed on the right hand side.

FIG. 4d Front view of latching member when installed on the left hand side.

FIG. 5a Top view of the retainer member.

FIG. 5b Front view of the retainer member.

FIG. 5c Side view of the retainer member.

FIG. 6a Top view of the blocker member.

FIG. 6b Front view of the blocker member.

FIG. 6c Side view of the blocker member.

FIG. 7a Side view of the bar member with a lock.

FIG. 7b Front view of the lock.

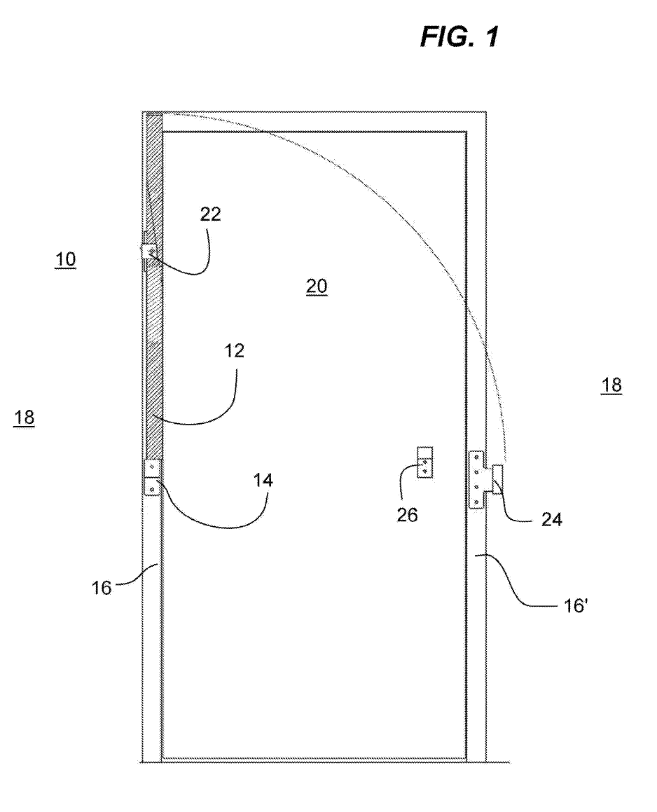

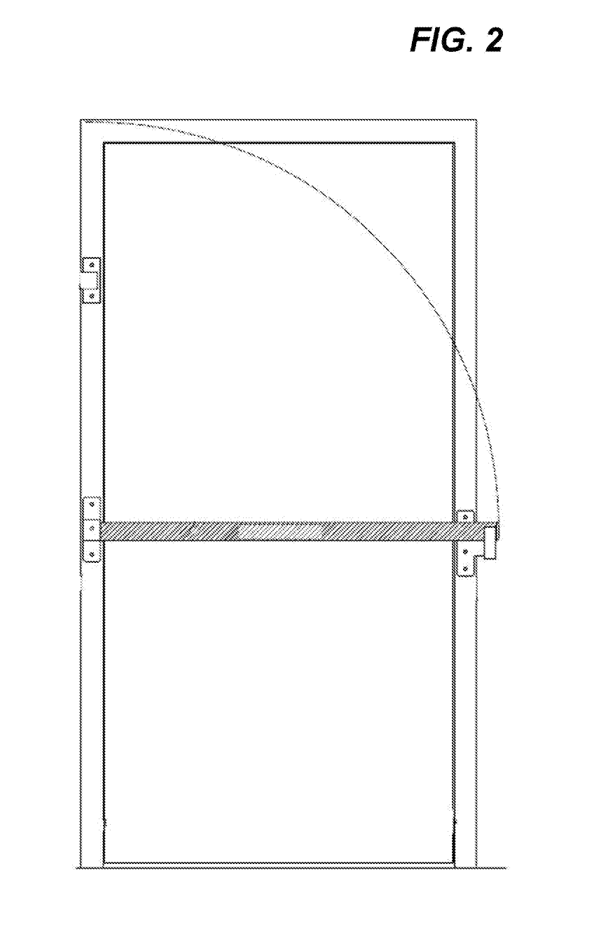

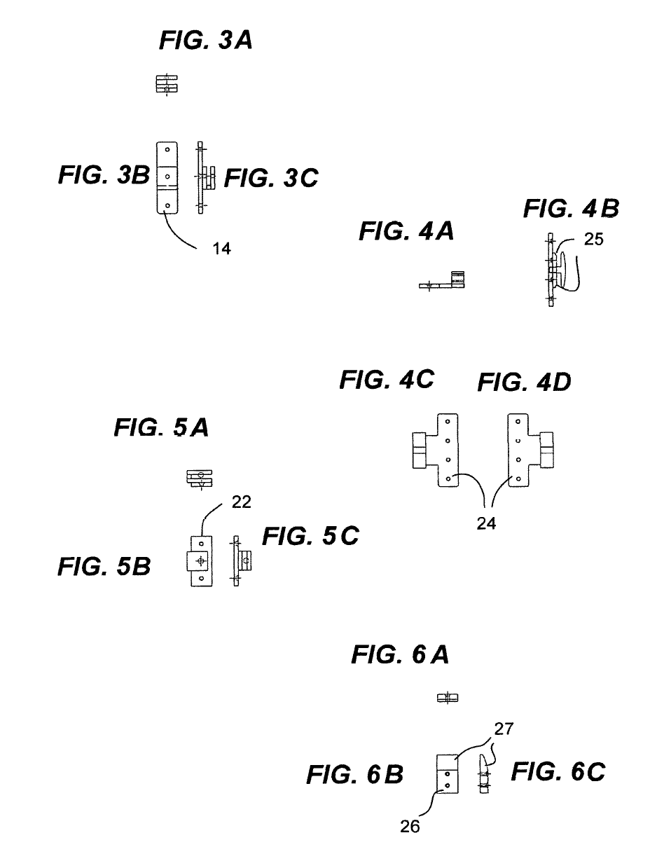

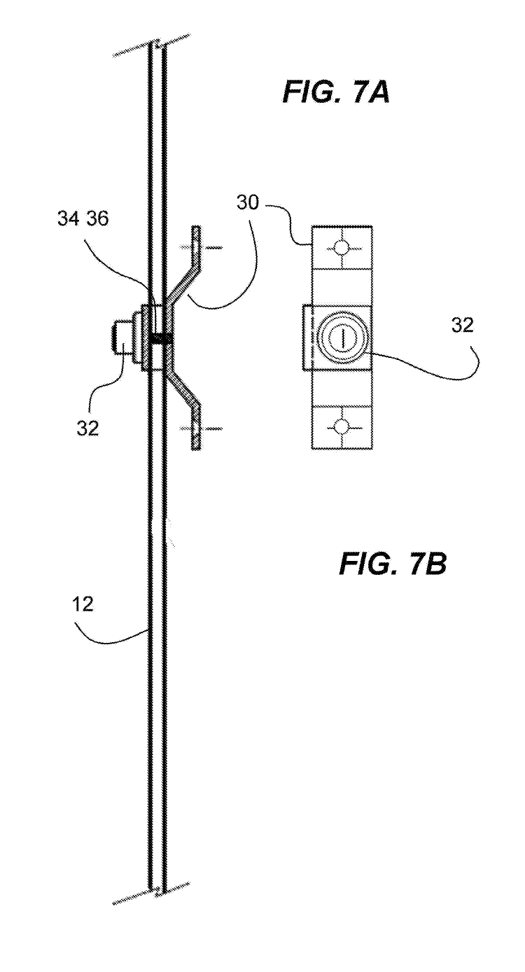

### DETAILED DESCRIPTION

A confinement locking bar (10) is comprised of a bar member (12) made from a strong and resilient material and pivotally bolted at a pivot bracket member (14), the latter itself being fixedly attached to a door frame (16) or any other strong location on a wall section (18) proximal to a door (20) that needs to be secured.

The bar member (12), when not in use, is held in a vertical position, that is substantially parallel to the door (20), by way of a retainer member (22). The bar member (12) also has a latching member (24) that it can latch onto when it is lowered into its horizontal “confinement” mode. The latching member (24) is located on the opposite door frame (16′) or any other strong location on the wall section (18) proximal to the door (20) to be secured.

Additionally, since the door (20) is likely to be recessed in relation to both sides of the door frame (16, 16′), (a door is generally thinner than a wall) a blocker member (26) is conveniently located on the door (20) at a location where it will be positioned in between the door (20) and the bar member (12) when it is in confinement mode. In this manner, the door (20) isn't even allowed “wiggling room”.

A small amount of leeway can make a difference between being able to knock down the door (20) or not. Those simple blocker members (26) can save lives. By not being able to hit the confinement locking bar (10) with the kinetic energy that the door (20) would gain if it had leeway, there is less of an effect on the structural integrity of the confinement locking bar (10).

The thickness of the blocker member (26) is wedge shaped so as to better receive the bar member (12), wherein the thinner side of the wedge is in the upper portion (27). And a receptacle portion (28) of the latching member (24) is also wedge shaped with a end segments (25) for the same reason. In this way, there is a much reduced probability that, by hurriedly lowering the bar member (12) it might bounce off the latching member and thus lose precious seconds in attempting to fit it in properly.

Preferably, the latching member (24) is two sided as per FIGS. 4c and 4d so that it can be installed on the right or left side of a door frame (16, 16′), depending on which side the door (12) is hinged.

According to some building codes, the bar member (12) needs to be locked when it is in its unused vertical configuration. In such cases, a lockable retainer member (30) has a locking member (32) that moves a pin member (34) in and out of a hole (36) made through the bar member (12).

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. A confinement locking bar having a bar member that is pivotally attached to a pivot bracket member fixedly connected to a wall section proximal one side of a door, and a latching member located on a wall section proximal an opposite side to said door for use by said bar member when it is in a horizontal configuration and wherein said bar member being held in a substantially vertical position, that is substantially parallel to said door by way of a retainer member; a blocker member fixedly attached to said door and positioned so that when said bar member is lowered said blocker member makes contact with said bar member so as to prevent any movement from said door.

2. The confinement locking bar of claim 1 wherein said blocker member is wedge shaped vertically wherein a thin side is is located in an upper portion.

3. The confinement locking bar of claim 1 wherein said latching member has a wedge shaped vertically wherein a thin side is is located in end segments.

4. The confinement locking bar of claim 1 wherein said latching member is two sided so that it can be installed on the right or left side of said door.

5. The confinement locking bar of claim 1 wherein said bar member is locked in its upright position by a lockable retainer member having a locking member that moves a pin member in and out of a hole made through said bar member so as to selectively lock and unlock said bar member.

6. The combination of a confinement locking bar and a door wherein said confinement locking bar has a bar member that is pivotally attached to a pivot bracket member fixedly connected to a wall section proximal one side of said door, and a latching member located on a wall section proximal an opposite side to said door for use by said bar member when it is in a horizontal configuration and wherein said bar member being held in a substantially vertical position, that is substantially parallel to said door by way of a retainer member; a blocker member fixedly attached to said door and positioned so that when said bar member is lowered said blocker member makes contact with said bar member so as to prevent any movement from said door.

7. The combination of claim 6 wherein said blocker member is wedge shaped vertically wherein a thin side is is located in an upper portion.

8. The combination of claim 6 wherein said latching member has a wedge shaped vertically wherein a thin side is is located in an upper portion.

9. The combination of claim 6 wherein said latching member is two sided so that it can be installed on the right or left side of said door.

10. The combination of claim 6 wherein said bar member is locked in its upright position by a lockable retainer member having a locking member that moves a pin member in and out of a hole made through said bar member so as to selectively lock and unlock said bar member.
